(19) United States
(12) Patent Application Publication
(10) Pub. No.: US 2023/0264149 A1
(43) Pub. Date: Aug. 24, 2023

(54) COMPACT WATER FILTRATION DEVICE

(71) Applicant: FGWRS, MONACO (MC)

(72) Inventor: Jean-Christophe LASSERRE, ANIANE (FR)

(21) Appl. No.: 18/012,013

(22) PCT Filed: Jun. 23, 2021
(86) PCT No.: PCT/EP2021/067265

§ 371 Date: Dec. 21, 2022

(30) Foreign Application Priority Data
Jun. 26, 2020 (FR) 2006732
Jul. 13, 2020 (MC) 2704

(51) Int. Cl. B01D 61/58; B01D 61/02; B01D 61/14; C02F 1/44

(52) U.S. Cl. CPC B01D 61/58; B01D 61/025; B01D 61/145; C02F 1/441; C02F 1/444; C02F 2103/002

(57) ABSTRACT

The invention relates to a method for filtering water comprising the use of a pump (14) to supply a filtering means (17), said supply being performed by simultaneous suction, for example by the same pump (14), through an ultrafiltration module (12).

The invention falls within the field of water treatment. In particular, the invention applies to the treatment of wastewater with a low to moderate pollution level, called graywater. This water, in particular in residential buildings, comes from shower and bathtub, bathroom sink or laundry machine discharge. In office buildings, it may also come from bathroom sinks. It is loaded with dust, detergents and hair, and excludes heavier pollutants such as kitchen sink discharge or a fortiori discharge from toilets or workshop effluents, which are handled by different pipe networks.

Many regions are experiencing increasing population density and a depletion of water resources, and it is therefore desirable to reuse graywater from buildings after satisfactory treatment, for various uses, in particular toilet flushing or cleaning water for parking lots, hangers or workshops, watering yards, or even for everyday tap water use, which involves a higher level of prior treatment, excluding human consumption of the drinking and cooking type. Having a controlled water quality can also allow reuse in showers and bathroom sinks. Such reuse is also beneficial in any context where potable water resources are limited, such as isolated sites, at high altitudes in the mountains, in areas having little infrastructure such as certain desert areas or areas remote from any urban unit, or in transport vehicles such as airplanes, ships or even trains. However, there is a technical challenge in transposing costly systems developed for highly specific situations such as space vehicles to an industrial level able to very broadly equip whole populations.

Known from document FR 2,994,965 A1 is a graywater recycling device for an airplane. This document describes a container for collecting graywater from a bathroom sink, a self-priming pump at the outlet of the container and a light ultrafiltration module for clarifying the recovered water, operating under 1.3 bar, and bringing the filtered water toward an expansion tank in which it is stored under 2 to 4 bar before being used to flush toilets. The water remains loaded in particular with various salts, which is not satisfactory for many applications, thus explaining why its use is limited to flushing toilets during journeys of the vehicle. To overcome the gradual clogging of the membrane, backwashing phases thereof are provided with clarified water stored in the expansion tank, with draining of the concentrates through an emptying circuit.

Document WO2013074228 A1 discloses a system for treating water with ultrafiltration by submerged membranes upstream and reverse osmosis downstream. A single permeate pump is installed at the outlet of several submerged membrane ultrafiltration modules and supplies the inlet of an overpressure pump and a tank whose contents are used for backwashing cycles of the ultrafiltration membranes at a pressure of 125 kPa (1.25 bar) so as to avoid cavitation. The overpressure pump is placed at the inlet of the reverse osmosis stage. Valves and a variable speed drive unit make it possible to modulate the suction of the various permeates of the ultrafiltration modules and redirect them, while allowing the operation of the overpressure pump of the reverse osmosis module. The system involves placing an intermediate container for collecting water having undergone ultrafiltration but not reverse osmosis, which takes up considerable space in the assembly, preventing easy large-scale development thereof.

There is therefore still a need for a compact and autonomous system for recycling graywater offering water treated to a thorough level of potability, and which can be deployed easily in the existing urban, suburban or rural habitat owing to a small footprint in a tight space and limited generated noise. This device may also be used as a method for treating drill water or rainwater for individual residences.

To address this problem, proposed is a water filtration device comprising an upstream membrane barometric clarification stage and a downstream advanced barometric purification stage, said downstream stage comprising an overpressure means upstream of a filtration means, the device also comprising a circuit for using water clarified by the device and accumulated in a tank to perform washing of said upstream stage periodically or at least when necessary.

Thus, a thorough treatment of the water to be filtered is performed, with two successive treatment stages. Additionally, the first stage being a membrane stage, it is provided to wash it using a circuit that uses the clarified and accumulated water. Consuming the network water for washing is thus avoided, which is very advantageous.

Remarkably, the device also comprises a command for controlling switching between two operating modes. This command can be of any type and may in particular be completely or, conversely, very partially automated, and can also be programmed into the electronics of the device, or under the control of a remote external device.

The first operating mode is a mode for producing filtered water and the second operating mode is a periodic maintenance mode.

The filtered water production mode comprises applying suction created by the operation of the overpressure means to a permeate outlet of the upstream stage. Thus, the overpressure means are used to amplify, or even preferably create, the pressure difference necessary for the operation of the upstream stage. The upstream stage can thus not have a booster pump, or even not be equipped with any pump specific to it. The two treatment stages operate in a synchronized manner, at least partially or even fully synchronized, and to this end there is no controlled accumulation of water in a tank at the outlet of the upstream stage.

The periodic maintenance operating mode in turn comprises circulating water toward the upstream stage to perform said washing from an accumulation tank of the device placed downstream of the permeate outlet of said filtration means. This tank makes it possible to accumulate clarified water (which may even be made potable by the advanced purification) that is used for washing. Since this water is treated at an advanced level, and for example up to the level of potability, it can also be used for the aforementioned uses, namely showers, bathroom sinks, watering yards, cleaning workshops, or flushing toilets.

Owing to these features, the space occupied by the device can be decreased, and the device can be given a format compatible with the existing buildings in the housing or service sectors. In fact, there is no need to store clarified water that has not been treated by the advanced purification stage, as had been previously proposed. Additionally, it is not necessary to multiply the number of mutually independent pumps, as had been previously proposed.

Optionally and advantageously,
the upstream stage may comprise a clarification module comprising a sealed rigid casing, within which a membrane is arranged on the water path, the casing being supplied at the inlet by a container for accumulated water to be treated;
the overpressure means may be a single pump, or a group of several pumps in parallel or in series;
the washing of the clarification module may be backwashing;
the filtration means of the downstream stage may comprise a reverse osmosis unit;
the upstream stage may comprise an ultrafiltration unit;
the overpressure means may comprise a self-priming pump;
the overpressure means may comprise a pump provided with an overflow valve configured to regulate the pressure at the outlet of the pump;
the periodic maintenance operating mode may also comprise circulating water toward the downstream stage from said accumulation tank placed downstream of the permeate outlet of the downstream stage, to wash the filtration means of the downstream stage;
the periodic maintenance operating mode may comprise washing cycles with clear water;
the periodic maintenance operating mode may comprise washing cycles with maintenance products.

Optionally, the method is applied to network graywater.

The invention will now be described in relation to the appended figures, provided as an illustration.

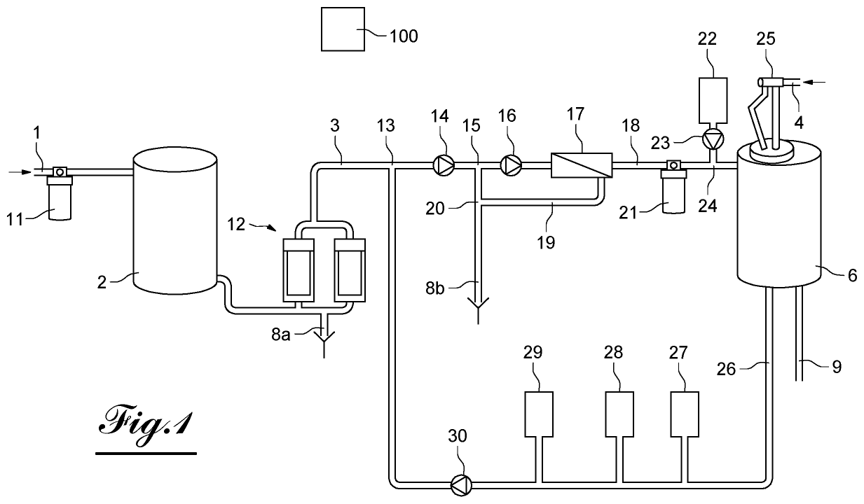

FIGS. 1 to 5 each show one embodiment of a method and a device according to the invention.

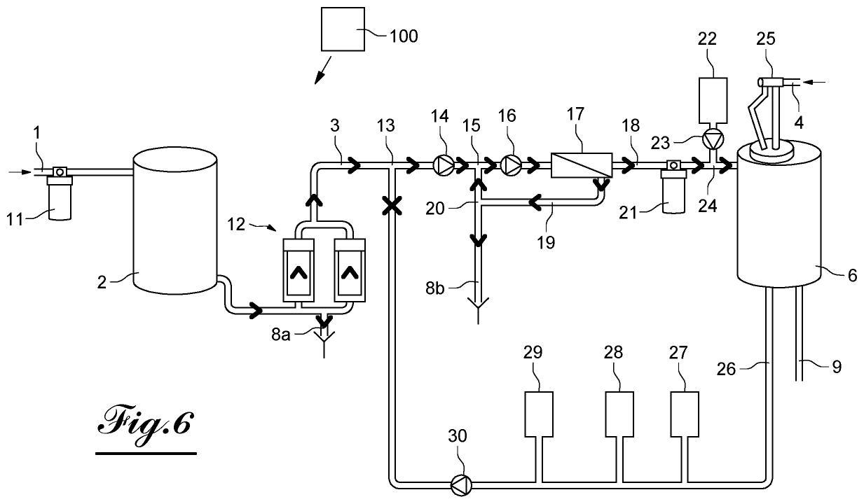

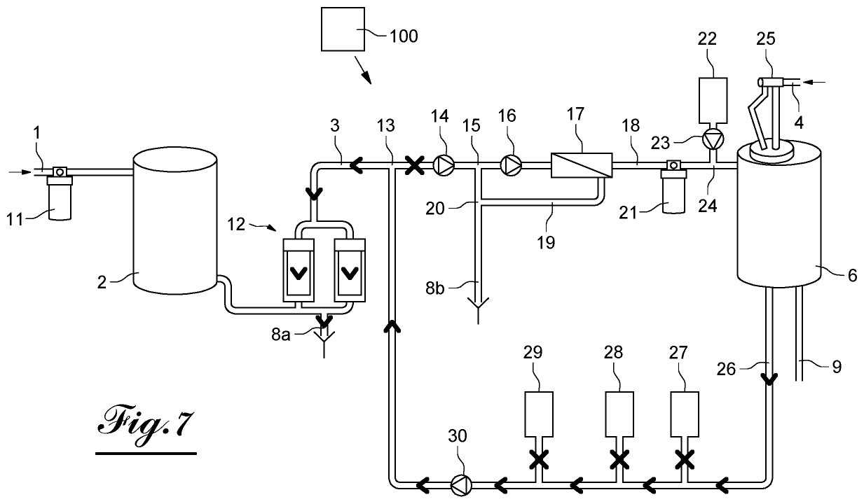

FIGS. 6 and 7 each show an operating mode of the embodiment of FIG. 1, taken as an illustrative example.

Various implemented components are identical in the various embodiments, and then bear the same reference numerals.

The invention is preferably implemented in the form of a module comparable to a cabinet, or a container of rectangular parallelepipedal shape and arranged vertically, of height smaller than a height under the common ceiling in a residence, or for example less than 2 m, supplied with power by the household electrical grid, for example 230 V, single phase. The footprint of the device outside the containers may be around 500 cm², with a nearly square shape.

[FIG. 1] At the inlet, the device comprises a water collection pipe, in particular to be connected to a building or allotment graywater discharge, which allows a container to be supplied with graywater 2, said container seeking to recover the effluents meeting the description of graywater for the building network. It also comprises a clear water (potable water) intake 4 for the building or allotment network.

At the outlet, the device comprises a treated water container 6, waste outlets 8a and 8b toward the sewers (drains), and a main outlet 9 for treated water. The clear water (potable water) intake 4 of the network is injected into the treated water tank 6 by means of a disconnector 25 (protective member protecting against water returning to the potable water network that is to be protected).

The graywater container 2 is protected upstream by a filter, on the graywater collection pipe 1, making it possible to separate the larger elements such as hair from the graywater circulating in the graywater collection pipe 1, which supplies the graywater container 2.

An outlet pipe 3 of the graywater container 2 makes it possible to circulate a stream of graywater stored in the graywater container in a multistage filtration system. The flow rate of this stream is smoothed due to the volume of graywater stored in the graywater container 2, which constitutes a buffer at the inlet.

The water treatment system, downstream of the graywater container 2 and on the outlet pipe 3 of the graywater container, comprises, at the outlet of the graywater container 2, a filtration system made up of an ultrafiltration module 12 followed by a reverse osmosis unit 17. The ultrafiltration module 12 is made up of hollow fiber membranes made from polymer materials placed in a rigid surrounding casing with an airtight and watertight wall. The filtration is done in a frontal mode from the outside toward the inside of the fibers. A drain makes it possible to discharge the concentrate and orient it toward the discharge outlet 8a.

The reverse osmosis unit 17 is made up of a polymer spiral membrane. The filtration is done in tangential mode. A drain here also makes it possible to discharge the concentrate (or retentate) and orient it toward the discharge outlet 8b.

The graywater passes through the ultrafiltration module 12 then, once clarified by the latter—it then constitutes the permeate—through the reverse osmosis membrane of the reverse osmosis unit 17. At the outlet of the reverse osmosis system, an outlet pipe 18 brings the filtered water—the permeate of the reverse osmosis unit—toward the filtered water container 6.

The reverse osmosis unit 17, which incorporates the membrane, has a concentrate (or retentate) outlet 19, the flow rate of which is oriented, at a separating point 20, in part toward the discharge outlet 8b, and in part toward a reinjection point 15 on the pipe 3, upstream of the reverse osmosis unit 17.

Between the reinjection point 15 and the reverse osmosis unit 17, a recirculation pump 16 is present on the pipe 3 and is used to create a tangential speed on the reverse osmosis membrane, such that the reverse osmosis membrane does not clog. This pump is called a circulation pump. Its downstream interfaces with the reinjection point of the pump 19 on the pipe 3 and its upstream interfaces with the inlet of the reverse osmosis unit 17.

An active charcoal filter 21 can be placed downstream of the reverse osmosis unit 17, on the outlet pipe 18, upstream of the filtered water container 6, to provide post-filtration on the water. Alternatively, the filter 21 can be replaced by an ozone generator.

The treated water is next disinfected using a tank 22 equipped with an injection pump 23, operating at an injection point 24 on the outlet pipe 18, before being oriented toward the treated graywater tank 6.

During the filtration process, which is organized in cycles controlled by the automaton 100, the water thus circulates from the graywater container 2 toward the treated water container 6, through the pipe 3.

However, backwashing cycles and cleaning cycles are also provided and controlled by the automaton 100. During these cycles, the water does not circulate from the graywater container 2 toward the treated water container 6.

A cleaning assembly made up of parallel hoses, solenoid valves and a pump allows the backwashing, during the maintenance cycles of the system, of the filters using the produced treated water. More specifically, a fraction of the produced treated water (the permeate of the reverse osmosis unit stored in the water container 6), is steered from the treated water container 6 by a pipe 26, in which fraction, in case of lack of supply water for uses downstream, clear water from the network is introduced to ensure the operation of the uses downstream by the treated water main outlet 9, and a pump 30 allows said fraction to be steered toward an injection point 13 on the pipe 3 during backwashing cycles, where the ultrafiltration membranes are washed in reverse.

This cleaning assembly also comprises storage containers for treatment solutions, for example a first solution container 27, a second container 28 and a third container 29. During certain chemical maintenance cycles, controlled quantities of the contents of these containers are introduced into the membranes by the pipe 26 toward the injection point 13 on the pipe 3. This makes it possible to unclog the ultrafiltration membranes by circulation and soaking of the membranes with various dedicated solutions.

The device is managed by an electronic board or an automaton and a specific program that manages the frequencies and filtration and backwashing cycles as well as the chemical cleaning cycles. This electronic board or this automaton and this program constitute the control member 100. It controls various valves making it possible to close or open the circulation of the water at different points of the pipes 3, 19 and 26.

Very originally, on the pipe 3, a pump 14 is placed between the ultrafiltration module 12 and the reverse osmosis unit 17 and makes it possible to create a vacuum downstream of the ultrafiltration membranes as well as an overpressure to supply the reverse osmosis loop.

In the embodiment of FIG. 1, the pump 14 is placed with its upstream interfacing with the injection point 13 of the pipe 26 and its downstream interfacing with the reinjection point 15 of the pipe 19.

This makes it possible to use a pump 14 that is only on in the direction from the ultrafiltration module 12 toward the reverse osmosis unit 17, since in this way, during cleaning or backwashing cycles, the flow rate coming from the pump 30 can reach the ultrafiltration membranes without passing through the pump 14.

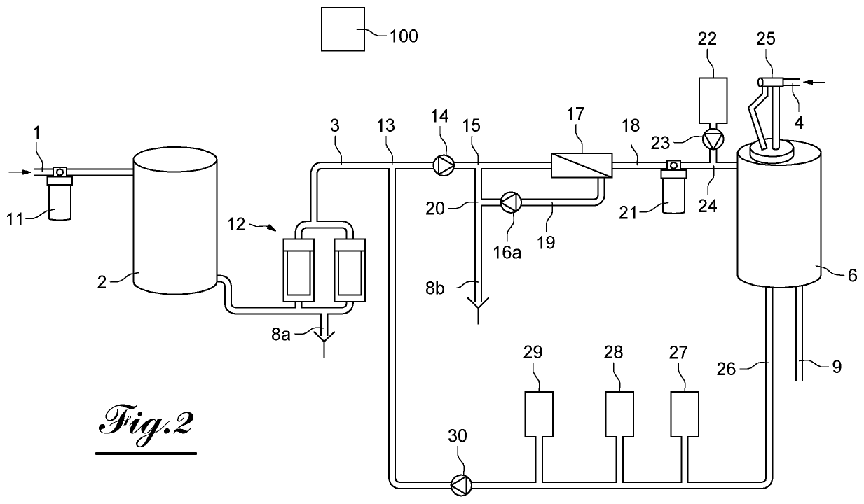

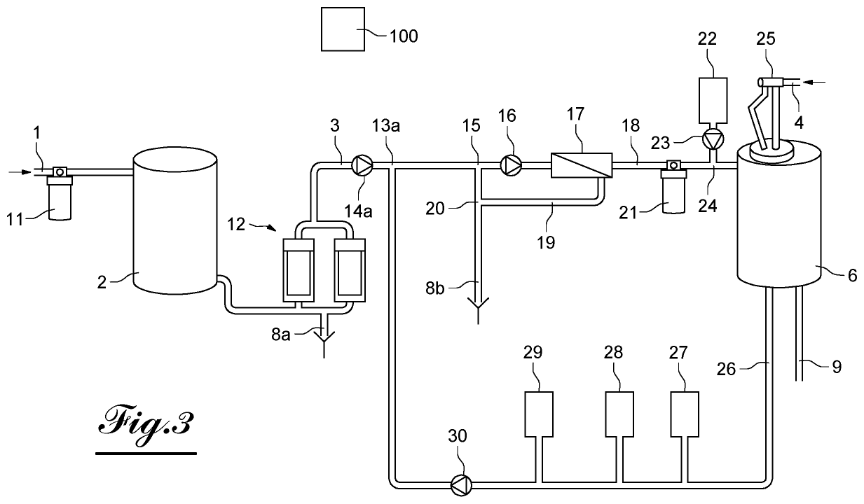

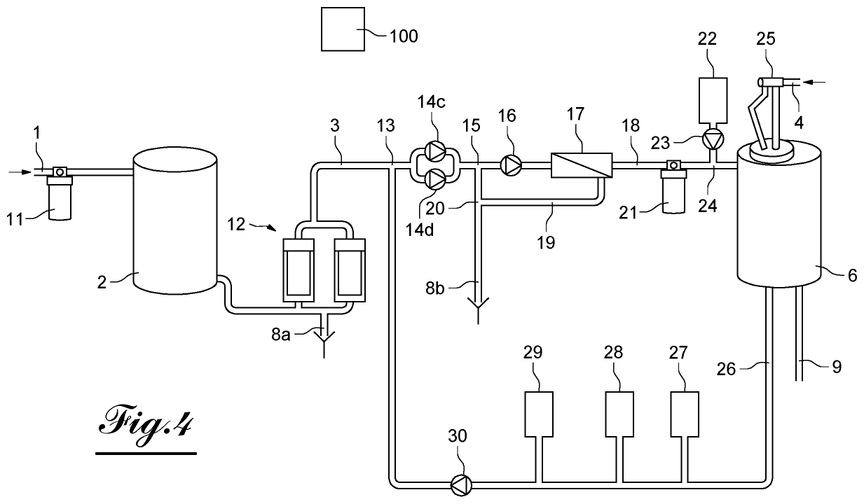

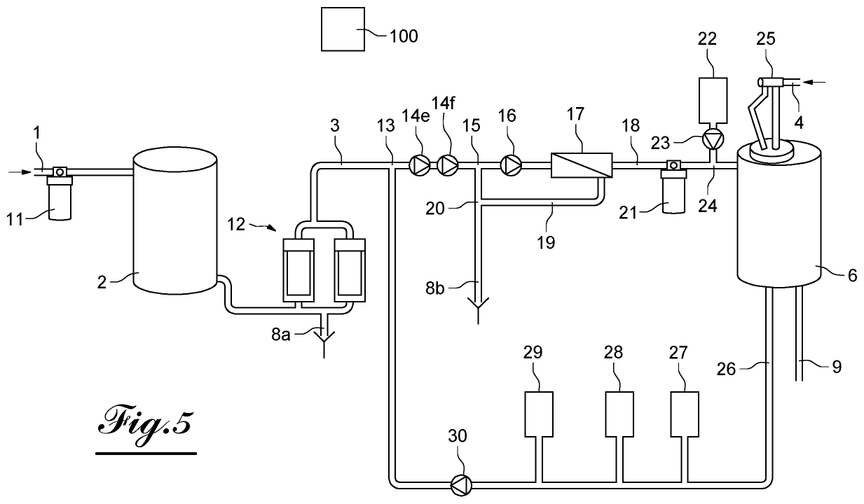

It is also specified that this pump 14 is provided with an overflow valve that makes it possible to regulate the pressure at the outlet of the pump without using a frequency converter.

[FIG. 2] According to the embodiment of FIG. 2, the circulation pump 16 is eliminated and replaced by a circulation pump 16a present on the pipe 19 with its upstream interfacing with the concentrate (or retentate) outlet of the reverse osmosis unit 17 and its downstream interfacing with the separation point 20 between the discharge outlet 8b and the reinjection point 15 of the pipe 19 on the pipe 3.

[FIG. 3] According to the embodiment of FIG. 3, the overpressure pump 14 is eliminated and replaced by an overpressure pump 14a present on the pipe 3 between the permeate outlet of the ultrafiltration module 12 and the reinjection point 13a of the pipe 26 on the pipe 3 with, for example, its upstream interfacing with the permeate outlet of the ultrafiltration module 12 and its downstream interfacing with the reinjection point 13a. The overpressure pump 14a is on in both directions to allow the circulation of washing water from the pipe 26 toward the ultrafiltration module 12, during backwashing and cleaning cycles. A circulation pump positioned like the one of FIG. 1 or the one of FIG. 2 can be present, or can also be absent.

[FIG. 4] According to the embodiment of FIG. 4, the overpressure pump 14 has been eliminated and replaced, with preservation of the downstream and upstream interfaces, by two pumps 14c and 14d that can be smaller and more powerful, placed in parallel with one another, and controlled in a synchronized manner.

[FIG. 5] According to the embodiment of FIG. 5, the overpressure pump 14 has been eliminated and replaced, here again with preservation of the downstream and upstream interfaces, by two pumps 14e and 14f that can be smaller and more powerful, and this time placed in series with one another, and controlled in a synchronized manner.

In the embodiments that have been described, the ultrafiltration module operates in a frontal mode, and is subject to backwashing. Alternatively, while remaining within the scope of the invention, an ultrafiltration module in tangential mode could be used, and the washing could be done from the front, or in the form of backwashing.

[FIG. 6] In FIG. 6, the operating mode is shown for producing filtered water comprising applying suction created by the operation of the pump 14 to the permeate outlet of the upstream stage. The water circulates from the tank 2 through the ultrafiltration membranes, then through the reverse osmosis unit, and lastly accumulates in the tank 6. The washing circuit is closed by a solenoid valve near the injection point 13.

[FIG. 7] In FIG. 7, the periodic maintenance operating mode is shown, comprising water circulation toward the upstream stage to perform the washing, here backwashing, from the accumulation tank placed downstream of the permeate outlet of the downstream stage. The reverse osmosis membrane is not washed in the figure, the inlet of the module being closed near the injection point 13. Cleaning products of the tanks 37 to 29 may optionally be used during certain maintenance phases, but in the embodiment shown, when the desalinated water from the tank 6 circulates to wash the ultrafiltration membranes, the cleaning products are not used.

The automaton 100 controls the switching between the operating modes of FIGS. 6 and 7 by acting on a series of solenoid valves and on the pumps 14 and 30, primarily.

1. A water treatment device comprising, on a pipe for water to be treated, an upstream membrane barometric clarification stage and a downstream advanced barometric purification stage, said downstream stage comprising an overpressure means upstream of a filtration means of the downstream stage, said filtration means of the downstream stage comprising a retentate outlet, the water treatment device also comprising a washing circuit for using water clarified by the water treatment device and accumulated in a tank to perform washing of said upstream membrane stage periodically, and the water treatment device being wherein it also comprises a command for controlling switching between an operating mode for producing filtered water comprising applying suction created by said overpressure means to a permeate outlet of the upstream stage and applying circulation to said retentate outlet in a pipe having a reinjection point on said pipe for water to be treated, on the one hand, and a periodic maintenance mode comprising circulating water toward the upstream stage from said tank that is placed downstream of a permeate outlet of said filtration means of the downstream stage, by said washing circuit, said washing circuit having an injection point on said pipe for water to be treated, said injection point of the washing circuit interfacing with the upstream of the overpressure means, and the reinjection point interfacing with the downstream of the overpressure means, on the other hand.

2. The water treatment device according to claim 1, wherein the upstream stage comprises a clarification module comprising a sealed rigid casing, within which a membrane is arranged, the casing being supplied at the inlet by a container for accumulated water to be treated.

3. The water treatment device according to claim 1, wherein the overpressure means is a single pump, or a group of several pumps in parallel or in series.

4. The water treatment device according to claim 1, wherein the washing of the upstream membrane stage comprises backwashing.

5. The water treatment device according to claim 1, wherein said filtration means of the downstream stage comprises a reverse osmosis unit.

6. The water treatment device according to claim 1, wherein a pump makes it possible to direct said clarified water toward the injection point on the pipe.

7. The water treatment device according to claim 1, wherein the upstream membrane barometric clarification stage comprises an ultrafiltration unit.

8. The water treatment device according to claim 1, wherein the overpressure means comprises a self-priming pump.

9. The water treatment device according to claim 1, wherein the overpressure means comprises a pump provided with an overflow valve configured to regulate the pressure at the outlet of the pump.

10. The water treatment device according to claim 1, wherein the periodic maintenance mode also comprises circulating water toward the downstream stage from said tank, to wash said filtration means of the downstream stage.

11. The water treatment device according to claim 1, wherein the periodic maintenance mode comprises washing cycles with said clear water.

12. A graywater filtration method, comprising using a water treatment device according to claim 1.
